(19) United States
(12) Patent Application Publication
(10) Pub. No.: US 2008/0280466 A1
(43) Pub. Date: Nov. 13, 2008

(54) USB memory device

(75) Inventors: Dean E. Sitz, Wahpeton, ND (US); Michael E. Reard, Fergus Falls, MN (US)

Correspondence Address: Attn: Eric D. Levinson;Imation Corp., P.O. Box 64898, St. Paul, MN, 55164-0898, US

(73) Assignee: Imation Corp.

(21) Appl. No.: 11/801,195

(22) Filed: May 8, 2007

(51) Int. Cl. H01R 13/60

(52) U.S. Cl. 439/131

(57) ABSTRACT

A USB memory device includes a circuit board, a connector, and a one-piece housing. The circuit board includes opposed major faces having a plurality of electrical contacts and a memory chip disposed on one of the major faces. The USB connector is coupled to a first end of the circuit board. The one-piece housing is over-molded over the circuit board and a portion of the connector, such that an interior of the one-piece housing contacts an entirety of the opposed major faces including the plurality of electrical contacts and the memory chip.

### BACKGROUND

Universal serial bus (USB) memory storage devices have gained wide acceptance from users of electronic devices. USB memory storage devices are highly portable, durable, and the memory storage is electronic, so there are no moving parts of the memory device that could potentially fail and cause a loss of data.

One useful USB memory device is a USB flash memory device. Flash memory is a solid-state, non-volatile, rewritable memory that has attributes of random access memory (RAM) and hard disk drive memory. Flash memory is a permanent memory that stores bits of data electronically in memory cells, similar to dynamic random access memory (DRAM), but it also has attributes of a hard disk drive in that when the power is turned off, the data remains in memory. Because of its high speed, durability, and low voltage requirements, flash memory is ideal for use in many applications, such as computers, including laptop computers, digital cameras, cell phones, printers, handheld computers, pagers, and audio recorders.

USB devices have a memory board connected to a connector, and some form of housing fitted to protect the memory board. The memory board includes the electrical connectors and memory chips. The connector extends from the memory board and is insertable into a USB receptacle of an electronic device. In this regard, all USB devices comply with the standard USB bus protocol developed by the USB Implementers Forum, Inc. The USB Standard is available at http://www.usb.org/home. There are generally two styles of USB connectors: Series A and Series B, and two styles of complementary receptacles: Series A receptacles and Series B receptacles. Series A connectors mate with only Series A receptacles, and Series B connectors mate with only Series B receptacles.

The housing usually includes an upper housing section mated to a lower housing section along a seam. The housing seam can provide a conduit for the entrance of moisture and debris into the housing, both of which can undesirably affect performance of the memory board. Thus, the proper assembly of the housing sections, which can be time-consuming, affects the portability, usability, and durability of the USB device.

USB devices have proven to be a popular and convenient form of permanently storing data in a portable format. Improvements in the portability and usability of USB devices will be welcomed by users of portable electronics.

For these and other reasons, there is a need for the present invention.

### SUMMARY

One embodiment provides a USB memory device including a circuit board, a connector, and a one-piece housing. The circuit board includes opposed major faces having a plurality of electrical contacts and a memory chip disposed on one of the major faces. The USB connector is coupled to a first end of the circuit board. The one-piece housing is over-molded over the circuit board and a portion of the connector, such that an interior of the one-piece housing contacts an entirety of the opposed major faces including the plurality of electrical contacts and the memory chip.

Another embodiment provides a method of over-molding a USB memory device. The method includes providing a circuit board and a USB connector coupled to a first end of the circuit board, where the circuit board includes opposed major faces having a plurality of electrical contacts and a memory chip disposed on one of the major faces. The method additionally includes molding a polymer material directly onto the circuit board to contact an entirety of the opposed major faces including the plurality of electrical contacts and the memory chip.

Another embodiment provides a USB memory device including a circuit board and a USB connector coupled to a first end of the circuit board, where the circuit board includes opposed major faces having electrical contacts and a memory chip that are separated one from the other to define interstices, and means for sealing an entirety of the interstices of the opposed major faces.

### BRIEF DESCRIPTION OF THE DRAWINGS

The accompanying drawings are included to provide a further understanding of the disclosure and are incorporated in as a part of this specification. The drawings illustrate example embodiments and, together with the description, serve to explain principles of the invention. Other embodiments and many of the intended advantages of the embodiments will be readily appreciated as they become better understood by reference to the following detailed description. The elements of the drawings are not necessarily to scale relative to each other. Like reference numerals designate corresponding similar parts.

FIG. 1 is a perspective cross-sectional view of a USB memory device according to one embodiment;

FIG. 2 is a cross-sectional view of another embodiment of a USB memory device; and

FIG. 3 is a perspective exploded view of a mold configured for injection molding a one-piece housing over a circuit board and a portion of a connector of a USB memory device according to one embodiment.

### DETAILED DESCRIPTION

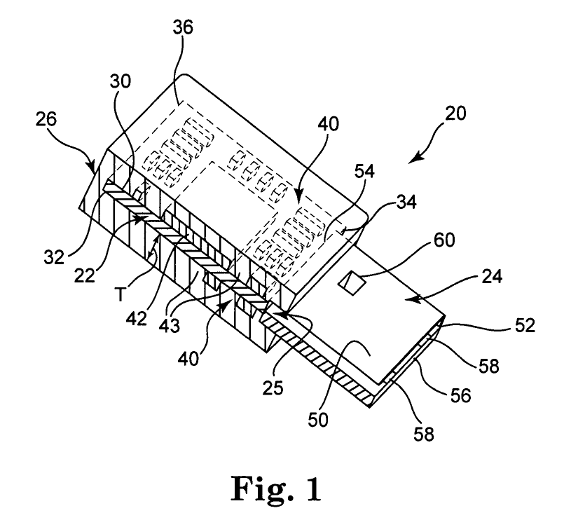

FIG. 1 is a perspective cross-sectional view of a USB memory device 20 according to one embodiment. The USB memory device 20 includes a circuit board 22 and a connector 24 coupled to the circuit board 22 to define an assembly 25, and a one-piece housing 26 over-molded over the circuit board 22 and a portion of the connector 24. In one embodiment, the one-piece housing 26 is molded as a single unit directly in contact with the circuit board 22 and a portion of the connector 24 such that the one-piece housing 26 is permanently and destructively coupled to the circuit board 22 and the connector 24. In this regard, the one-piece housing 26 is molded in place without the use of a separate adhesive or other bonding material. The one-piece housing 26 is permanently and destructively coupled to the circuit board 22, meaning that the housing 26 cannot be removed from the circuit board 22 without destroying the functionality of the circuit board 22.

The circuit board 22 includes a first face 30 opposite a second face 32, where the faces 30, 32 extend between a first end 34 and a second end 36 of the circuit board 22. In one embodiment, the circuit board 22 includes a plurality of electrical contacts 40 and at least one memory chip 42 disposed on one of the faces 30, 32. In other embodiments, the circuit board 22 includes a controller chip, test points, one or more crystal oscillators, a light emitting diode, a write protect switch and/or additional memory chips. In one embodiment, the memory chip 42 is a flash memory chip and the device 20 is a flash drive, although other forms of memory chips are also acceptable. In one embodiment, the circuit board 22 is a printed circuit board and the electrical contacts 40 and the memory chip 42 rise above the faces 30, 32 of the circuit board 22.

The connector 24 includes a sheath 50 having a leading end 52 separated from a base 54. In one embodiment, the base 54 of the connector 24 is coupled to the first end 34 of the circuit board 22. In general, the sheath 50 protectively surrounds a tongue 56 of the connector 24, where the tongue 56 includes a plurality of electrical contacts 58 in communication with the circuit board 22. In one embodiment, the sheath 50 is formed of metal and includes a pair of retention windows 60 (one shown) configured to couple with a prong of a receptacle into which the USB memory device 20 is plugged. One of skill in the art will recognize that the connector 24 can include a cap or other form of cover for the connector 24. One embodiment provides molding a cap for the connector 24 when the one-piece housing 26 is molded.

The one-piece housing 26 is molded in contact with an entirety of the opposed major faces 30, 32 including the plurality of electrical contacts 40 and the memory chip 42. In one embodiment, the one-piece housing 26 includes a single homogenous polymer characterized by an absence of an adhesive disposed between the housing 26 and the circuit board 22. In one embodiment, the electrical components disposed on the faces 30, 32 of the circuit board 22 are spaced one from the other to define interstices 43, and the one-piece housing 26 is molded from a room temperature polymer that is configured to flow at room temperature and fill the interstices 43. In one embodiment, the one-piece housing 26 is over-molded over the circuit board 22 and a portion of the connector 24 at a sidewall thickness T of between about 1-3 mm to hermetically seal the circuit board 22 from environmental moisture and debris.

In this specification, room temperature means a temperature ranging between about 60 degrees Fahrenheit to about 80 degrees Fahrenheit. Hermetically seal means to seal the circuit board 22 from air that could potentially and undesirably transport moisture and debris into contact with the components disposed on the circuit board 22. Thus, hermetically seal means that there are substantially no gaps of spaces between the components disposed on the circuit board 22 that are not covered/coated/sealed by the one-piece housing 26. The conventional USB memory devices include a housing molded apart from the circuit board; when the housing is subsequently mounted around the circuit board small spaces invariably exist between the housing and the circuit board, meaning that the conventional USB memory devices do not provide a housing that is hermetically sealed to the circuit board.

Suitable materials for molding of the one-piece housing 26 onto the circuit board 22 include silicone in general, and room temperature vulcanized (RTV) silicone rubber (e.g. liquid silicone rubber) in particular. Depositing the one-piece housing 26 onto and over the circuit board 22 at room temperature prevents the undesirable heating of the electrical contacts 40 on the board 22. In addition, depositing the one-piece housing 26 at relatively low pressures of less than 40 pounds-per-square inch (psi), and preferably at less than about 20 psi minimizes the possibility of distorting the circuit board 22 or damaging the components on the board 22.

In one embodiment, the material employed to fabricate the one-piece housing 26 has a hardness/durometer that is suited to enable the housing 26 to withstand transportation by a user, for example, when carried in the user's pocket or briefcase. In one embodiment, the housing 26 material has a hardness/durometer represented on the shore A-scale of between about 30-90 shore A hardness. One exemplary sidewall thickness T for housing 26 is about 2 mm. One suitable material for molding of the one-piece housing 26 includes SILASTIC LC-40-2004 liquid silicone rubber having a shore A hardness of about 44 available from Dow Coming, Midland, Mich. Other materials may be employed for housing 26, including materials having hardness values greater than the shore A hardness of the SILASTIC LC-40-2004 liquid silicone material, such as SILASTIC LC-70-2004 liquid silicone having a shore A hardness of 70.

In one embodiment, the one-piece housing 26 is formed of a condensation cure two-component silicone rubber including a tin catalyst. Tin catalyst silicone rubbers are configured to cure at room temperature over virtually any surface, such as the uneven faces 30, 32 having interstices 43 as provided by the circuit board 22. In general, the tin catalyst silicone rubber is configured to mix easily and de-air such that the silicone rubber will cure with a minimum of shrinkage. In another embodiment, the one-piece housing 26 includes a platinum catalyzed two-component silicone rubber having superior heat resistance and cure with essentially no shrinkage. Suitable tin catalyzed or platinum catalyzed silicone rubbers are available from Silicones, Inc., High Point, N.C. Other suitable materials, including low temperature epoxies and other rubbers are also acceptable.

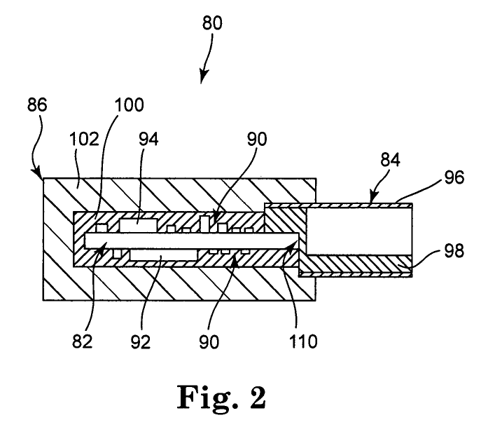

FIG. 2 is a cross-sectional view of another USB memory device 80. The USB memory device 80 includes a circuit board 82, a connector 84 coupled to the circuit board 82, and a single unitary housing 86 molded over the circuit board 82 and a portion of the connector 84. The circuit board 82 is similar to the circuit board 22 (FIG. 1) and includes a plurality of electrical contacts 90, a memory chip 92, and a controller chip 94. The electrical contacts 90 and chips 92, 94 are electrically coupled to faces of the circuit board 82.

The connector 84 is similar to the connector 24 (FIG. 1) and includes a sheath 96 protectively surrounding a tongue 98, as is typical with USB connectors.

In one embodiment, the housing 86 includes a sleeve 100 in contact with the circuit board 82, and a casing 102 over-molded over the sleeve 100 and a portion of the connector 84. In one embodiment, the circuit board 82 and the connector 84 are coupled to define an assembly 110, where the circuit board 82 is “potted” in the sleeve 100 such that the sleeve 100 fills the interstices formed between the plurality of electrical contacts 90 and memory chips 92, 94. In this regard, the potted circuit board 82 is protected by the sleeve 100, and the sleeve 100 is configured to withstand additional processing that can be done at temperatures above room temperature and pressures above 40 psi. For example, in one embodiment the sleeve 100 is fabricated from a room temperature curable epoxy and the casing is molded from a thermoplastic polymer processed at a temperature of about 400 degrees Fahrenheit.

Suitable materials for sleeve 100 include potting and encapsulation materials configured to protect electronic circuitry and assemblies from potentially damaging conditions such as moisture, corrosive chemicals, excessive heat, vibration, mechanical impact, thermal shock, and abrasion that might possibly occur while the USB memory device 80 is in use.

In one embodiment, sleeve 100 includes a rigid room temperature curable epoxy. In another embodiment, sleeve 100 includes a flexible room temperature curable epoxy. Other suitable materials for sleeve 100 include polyurethanes and silicone compounds. In one embodiment, sleeve 100 includes a two-part epoxy system configured to cure at ambient temperatures, for example, between 60-80 degrees Fahrenheit. One suitable epoxy is identified as EP21FRLVSP available from Masterbond, Inc., Hackensack, N.J., having a mixed viscosity of between 25,000-30,000 centipoise and a set-up time of between 30-60 minutes with a cure schedule of about 24-48 hours at the ambient temperature.

Casing 102 is configured to be conformably formed over the sleeve 100 to define one-piece housing 86. In one embodiment, an interior portion of sleeve 100 contacts the electrical components 90 and memory chips 92, 94, and casing 102 defines an exterior portion of the housing 86. Suitable materials for the casing 100 include RTV silicone, thermoplastic elastomers such as styrene block copolymers, thermoplastic urethanes, thermoplastic vulcanizates, thermoplastic olefins, thermoplastic co-polyesters, and other suitable thermoplastic polymers some of which are processed above 200 degrees Fahrenheit.

In another embodiment, the assembly 110 is potted with a two-part epoxy such that the sleeve 100 is formed over the circuit board 82 and a portion of the connector 84. The assembly 110 and the sleeve 100 are then over-molded with the casing 102.

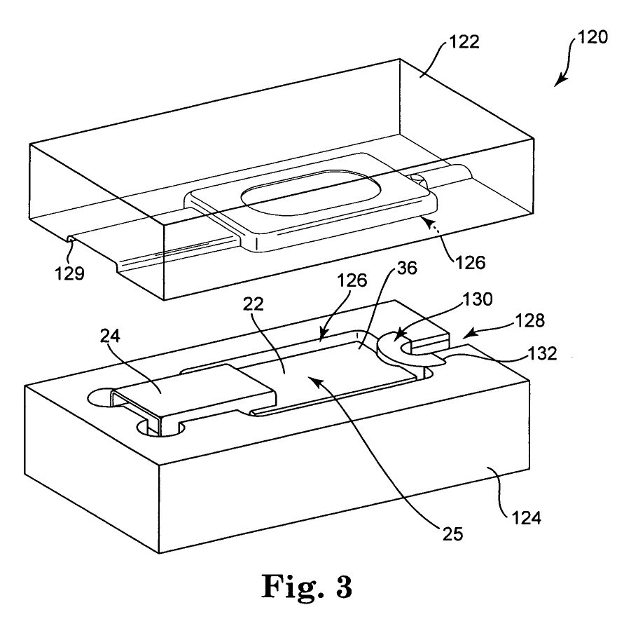

FIG. 3 is a perspective view of a mold 120 configured to over-mold a USB assembly with a one-piece housing according to one embodiment. The mold 120 includes a first mold section 122 and a second mold section 124 that combine to define a cavity 126 configured to receive the assembly 25. The assembly 25 is simplified in the view of FIG. 3 for ease of illustration, but includes components disposed on the circuit board 22. In another embodiment, the cavity 126 is configured to receive the assembly 110 and the sleeve 100 potted about a portion of the assembly 110.

In one embodiment, the first mold section 122 is an upper mold section, and the second mold section 124 is a lower mold section configured to reciprocally mate with the upper mold section 122. When the mold sections 122, 124 are assembled together they define an injection port 128 and a vent 129 in communication with the cavity 126. In one embodiment, a flow restrictor 130 is disposed at a trailing end 132 of the injection port 128 and is configured to support the assembly 25 during injection molding of the one-piece housing 26 (FIG. 1) over the assembly 25.

During a molding operation, the assembly 25 is positioned in the cavity 126 such that the flow restrictor 130 supports the second end 36 of the circuit board 22. The flow restrictor 130 is configured such that material injected into the injection port 128 flows over the top major face 30 and the bottom major face 32 (FIG. 1) of the circuit board 22 to evenly encapsulate the assembly 25. In one embodiment, the cavity 126 is configured to enable injected polymer material to contact an entirety of the opposed major faces 30, 32, the interstices 43 (FIG. 1) between components on the circuit board 22, and a portion of the connector 24.

In one embodiment, the over-molding of the one-piece housing 26 (FIG. 1) is processed at an ambient room temperature ranging between about 60 degrees Fahrenheit to about 80 degrees Fahrenheit. In one embodiment, the material injected into the injection port 128 is an RTV liquid silicone injected at room temperature at a mold pressure of between about 10 to 40 psi, preferably about 15 to 35 psi. In this manner, the one-piece housing 26 is over-molded over the assembly 25 at temperature and pressure conditions that are configured to minimize the potential thermal damage and/or flexing of the circuit board 22 and the electrical components disposed on the circuit board 22. Other molding conditions, including higher temperature and higher pressure conditions are also acceptable.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of a USB memory device including a one-piece over-molded housing as discussed herein. Therefore, it is intended that this invention be limited only by the claims and the equivalents thereof.

What is claimed is:

1. A USB memory device comprising:
a circuit board including opposed major faces having a plurality of electrical contacts and a memory chip disposed on one of the major faces;
a USB connector coupled to a first end of the circuit board; and
a one-piece housing over-molded over the circuit board and a portion of the connector; an interior of the one-piece housing contacting an entirety of the opposed major faces including the plurality of electrical contacts and the memory chip.

2. The USB memory device of claim 1, wherein the one-piece housing comprises a silicone rubber that is configured to flow at room temperature during molding to contact the entirety of the opposed major faces including the plurality of electrical contacts and the memory chip.

3. The USB memory device of claim 2, wherein the electrical contacts and the memory chip are spaced one from the other to define a plurality of interstices, and the silicone rubber fills an entirety of the interstices.

4. The USB memory device of claim 1, wherein the one-piece housing comprises a sleeve in contact with the circuit board, and a casing over-molded over the sleeve and a portion of the connector.

5. The USB memory device of claim 4, wherein the sleeve comprises an epoxy sleeve, and the casing comprises one of a rubber and a thermoplastic elastomer.

6. The USB memory device of claim 1, wherein the USB connector comprises a base coupled to a first end of the circuit board and a leading end separated from the base, the one-piece housing over-molded over the base of the connector.

7. The USB memory device of claim 1, wherein the one-piece housing comprises one homogenous polymer characterized by an absence of an adhesive disposed between the housing and the circuit board.

8. A method of over-molding a USB memory device, the method comprising:
providing a circuit board including opposed major faces having a plurality of electrical contacts and a memory chip disposed on one of the major faces, and a USB connector coupled to a first end of the circuit board; and
molding a polymer material directly onto the circuit board to contact an entirety of the opposed major faces including the plurality of electrical contacts and the memory chip.

9. The method of claim 8, wherein molding a polymer material over the circuit board comprises room temperature molding a polymer material over the circuit board.

10. The method of claim 9, wherein molding a polymer material over the circuit board comprises molding a polymer material over the circuit board at a mold pressure of less than about 20 psi.

11. The method of claim 8, wherein the plurality of electrical contacts define a plurality of interstices, and molding a polymer material directly onto the circuit board comprises over-molding the circuit board with a polymer material that fills the plurality of interstices.

12. The method of claim 8, wherein molding a polymer material over the circuit board comprises molding a polymer material over a portion of the USB connector coupled to a first end of the circuit board.

13. The method of claim 8, wherein molding a polymer material over the circuit board comprises:
potting the circuit board in a sleeve of epoxy; and
over-molding the sleeve of epoxy with a polymer casing.

14. A USB memory device comprising:
a circuit board including opposed major faces having electrical contacts and a memory chip that are separated one from another to define interstices;
a USB connector coupled to a first end of the circuit board; and
means for sealing an entirety of the interstices of the opposed major faces.

15. The USB memory device of claim 14, wherein the means for sealing an entirety of the interstices comprises over-molding a one-piece housing over the circuit board.

16. The USB memory device of claim 15, wherein over-molding a one-piece housing over the circuit board comprises over-molding a one-piece housing over the circuit board and a portion of the connector.

17. The USB memory device of claim 14, wherein the means for sealing an entirety of the interstices comprises flowing a silicone rubber at room temperature over an entirety of the opposed major faces.

18. The USB memory device of claim 14, wherein the means for sealing an entirety of the interstices comprises hermetically sealing the opposed major faces of the circuit board with a polymer.

19. The USB memory device of claim 14, wherein the means for sealing an entirety of the interstices comprises potting the circuit board in an epoxy sleeve and over-molding the sleeve and a portion of the connector with a polymer casing.

20. The USB memory device of claim 19, wherein the epoxy sleeve comprises a room temperature flowable epoxy and the polymer casing comprises a thermoplastic polymer that flows at above room temperature.
